(19) United States
(12) Patent Application Publication
(10) Pub. No.: US 2006/0243540 A1
(43) Pub. Date: Nov. 2, 2006

(54) Elevator

(76) Inventors: Jorma Mustalahti, Hyvinkaa (FI); Esko Aulanko, Kerava (FI)

Correspondence Address: HARNESS, DICKEY & PIERCE, P.L.C., P.O. BOX 8910, RESTON, VA, 20195, US

(21) Appl. No.: 11/430,845

(22) Filed: May 10, 2006

Related U.S. Application Data
(63) Continuation of application No. PCT/FI04/00705, filed on Nov. 22, 2004.

(30) Foreign Application Priority Data
Nov. 24, 2003 (FI) 20031708

(51) Int. Cl. B66B 7/10

(52) U.S. Cl. 187/412

(57) ABSTRACT

An elevator, preferably an elevator without counterweight, which has an elevator car suspended by means of a set of hoisting ropes comprising one rope or a plurality of parallel ropes. The elevator has a traction sheave that moves the elevator car by means of the hoisting ropes. The elevator contains rope portions of hoisting ropes going upwards and downwards from the elevator car, and it has a compensating device acting on the hoisting ropes to equalize and/or compensate rope tension and/or rope elongation. The compensating device acting on the hoisting ropes of the elevator, said compensating device having at least a first range which is a structural operating range of the compensating device and at least a second range which is a preselected compensation range of the compensating device, is provided with at least one switching element for monitoring whether the compensating device remains within the preselected compensation range.

This application is a continuation of PCT/FI2004/000705, filed on Nov. 22, 2004, which is an international application claiming priority from FI 20031708, filed Nov. 24, 2003, the entire contents of which are hereby incorporated by reference.

The present invention relates to an elevator as defined in the preamble of claim 1 and to a method as defined in the preamble of claim 9 for detecting a deviation of a compensating device from a preselected compensating range in an elevator.

One of the objectives in elevator development work is to achieve an efficient and economical utilization of building space. In recent years, this development work has produced various elevator solutions without machine room, among other things. Good examples of elevators without machine room are disclosed in specifications EP 0 631 967 (A1) and EP 0 631 968. The elevators according to these specifications are fairly efficient in respect of space utilization as they have made it possible to eliminate the space needed for the machine room in the building without a need to enlarge the elevator shaft. The machine used in the elevators according to these specifications is compact in at least one direction, but in other directions it may be much larger than conventional elevator machines.

In these basically good elevator solutions, the space and placement of the hoisting machine limits the freedom of choice in elevator lay-out solutions. The arrangements for the passage of the hoisting ropes require space. The space required by the elevator car itself on its track, and likewise the space needed for the counterweight, can not be easily reduced, at least at a reasonable cost and without compromising on the performance and quality of operation of the elevator. In a traction sheave elevator without machine room, installing the hoisting machine in the elevator shaft, especially in the case of solutions with machine above, is often difficult because the hoisting machine is a fairly heavy and large object. Especially in elevators for larger loads, speeds and/or hoisting heights, the size and weight of the machine are a problem in respect of installation, even so much so that the required machine size and weight have in practice limited the scope of application of the concept of elevator without machine room, or at least retarded the introduction of said concept in larger elevators. The space available in the elevator shaft in elevator modernization projects has often limited the scope of application of the concept of elevator without-machine room. Often, especially in cases of modernization or replacement of hydraulic elevators, it has not been practical to apply a roped elevator solution without machine room, due to insufficient space in the elevator shaft especially in a situation where no counterweight has been used in the hydraulic elevator solution to be modernized/replaced. The drawbacks of elevators provided with a counterweight include the cost of the counterweight and the space required for the counterweight in the elevator shaft. Drum-driven elevators, which at present are quite rare, have the disadvantages of heavy and complicated hoisting machines and their high power and/or torque requirements. Prior-art elevator solutions without counterweight are exotic and no appropriate solutions are known. So far, it has not been technically or economically reasonable to make elevators without counterweight. One solution like this is disclosed in specification WO9806655. A recent international patent application discloses a feasible solution. In prior-art elevator solutions without counterweight, the tensioning of the hoisting rope is implemented using a weight or spring, and that is not an attractive approach to implementing the tensioning of the hoisting rope. Another problem with elevators without counterweight, when long ropes are used e.g. due to a large hoisting height or large suspension ratios used, the compensation of rope elongations and at the same time, due to rope elongations, the friction between the traction sheave and the hoisting ropes is insufficient for the operation of the elevator. A further problem is how to ensure the compensation of rope elongations and the operating reliability of the compensating device.

The general aim of the invention is to achieve at least one the following objectives. On the one hand, it is an objective of the invention to develop the elevator without machine room so as to achieve more efficient space utilization in the building and in the elevator shaft than before. This means that the elevator should permit of being installed in a relatively narrow elevator shaft if necessary. On the other hand, it is an objective of the invention to control dangerously large rope elongation of the hoisting ropes and to eliminate danger situations caused thereby. Another objective is to ensure a safe adjustment range and compensation range for the rope elongation compensating system and a simple implementation of monitoring of the condition of the hoisting ropes.

The elevator of the invention is characterized by what is disclosed in the characterization part of claim 1. The method of the invention is characterized by what is disclosed in the characterization part of claim 9. Other embodiments of the invention are characterized by what is disclosed in the other claims. Inventive embodiments are also presented in the description part of the present application. The inventive content disclosed in the application can also be defined in other ways than is done in the claims below. The inventive content may also consist of several separate inventions, especially if the invention is considered in the light of explicit or implicit sub-tasks or in respect of advantages or sets of advantages achieved. In this case, some of the attributes contained in the claims below may be superfluous from the point of view of separate inventive concepts.

By applying the invention, one or more of the following advantages, among others, can be achieved:
monitoring of the hoisting ropes and compensation range needed in the compensating device can be easily implemented because the compensation range of the compensating device is limited due to its structure
by monitoring the compensation range in the compensating device, information regarding deviation from the preselected compensation range is obtained quickly and at the same time the danger situation resulting from the deviation can be detected in time
safety of the elevator of the invention is better ensured, especially in the case of an elevator without counterweight
the elevator can be stopped and its use can be prevented in time due to a factor which has been caused by a disturbance or some other corresponding danger situation detected by the compensating device and which activates the switching elements of the compensating device,
monitoring of the condition of the hoisting ropes of the elevator is easy and simple to implement by applying the invention
the elevator control system can be supplied with information and/or about some other danger situation that causes activation of the switching elements of the hoisting rope compensating device
using the method and elevator of the invention, it is possible to transmit information regarding deviation from the preselected compensation range even to a remote elevator monitoring system, and thus to transmit information regarding the need of maintenance of the elevator
information regarding the need of maintenance of the elevator of the invention is obtained quickly, at least as far as the hoisting ropes and/or compensating device are concerned
the invention enables easy and fast detection of various disturbance situations and danger situations in the elevator, such as e.g. damaged and blocked diverting pulleys, disturbances of rope passage in the elevator, changes in rope lengths, situations where the elevator car is driven onto the buffer or the safety gear of the elevator grips and/or other corresponding disturbance situations
in addition, by applying the invention, the operation of the compensating device in the desired manner can be easily ensured.

The primary area of application of the invention is elevators designed for transporting people and/or freight. A normal area of application of the invention is in elevators whose speed range is about or below 1.0 m/s but may also be higher. For example, an elevator traveling at a speed of 0.6 m/s is easy to implement according to the invention.

In the elevator of the invention, normal elevator ropes, such as generally used steel wire ropes, are applicable. The elevator may use ropes of synthetic material and rope structures with a synthetic-fiber load-bearing part, such as e.g. so-called “aramid” ropes, which have recently been proposed for use in elevators. Applicable solutions are also steel-reinforced flat belts, especially because of the small deflection radius they permit. Particularly advantageously applicable for use in the elevator of the invention are elevator hoisting ropes twisted from e.g. round and strong wires. Using round wires, the rope can be twisted in many ways using wires of the same or different thicknesses. In ropes well applicable with the invention, the wire thickness is below 0.4 mm on an average. Well-suited ropes made from strong wires are those in which the average wire thickness is under 0.3 mm or even under 0.2 mm. For example, thin-wired and strong 4-mm ropes can be twisted relatively advantageously from wires such that the average wire thickness in the finished ropes is between 0.15 . . . . 0.25 mm, in which the thinnest wires may even have a thickness of only about 0.1 mm. Thin rope wires can be easily made quite strong. In the invention, rope wires having a strength greater than about 2000 N/mm². Appropriate rope wire strengths are 2300-2700 N/mm². In principle, it is possible to use rope wires having a strength of about 3000 N/mm² or even more.

In the elevator applying the invention, the elevator car is suspended on a set of hoisting ropes comprising one rope or a number of parallel ropes, and the elevator has a traction sheave which moves the elevator car by means of the hoisting ropes. The elevator of the invention comprises rope portions of hoisting ropes going upwards and downwards from the elevator car. The elevator also has a compensating device acting on the hoisting ropes to equalize and/or compensate rope tension and/or rope elongation. The compensating device acting on the hoisting ropes of the elevator comprises at least a first range, which is a structural operating range, and at least a second range, which is a preselected compensation range of the compensating device. In addition, the elevator comprises at least one switching element for monitoring whether the compensating device remains within the preselected compensation range.

In the method of the invention for detecting a deviation of a compensating device from a preselected compensating range in an elevator, in which elevator the elevator car is at least partially suspended on a set of hoisting ropes comprising one rope or a number of parallel ropes. The elevator has a traction sheave which moves the elevator car by means of the hoisting ropes, and the elevator comprises rope portions of hoisting ropes going upwards and downwards from the elevator car. In addition, the elevator has a compensating device acting on the hoisting ropes to equalize and/or compensate rope tension and/or rope elongation. In the method, at least one switching element is used in the compensating device to monitor whether the compensating device of the elevator remains within the preselected compensation range.

By increasing the contact angle using a rope pulley functioning as a diverting pulley, the grip between the traction sheave and the hoisting ropes can be improved. Therefore, a car of lighter weight as well as smaller size can be used, thus increasing the space-saving potential of the elevator. A contact angle of over 180° between the traction sheave and the hoisting rope is achieved by utilizing a diverting pulley or diverting pulleys. The need to compensate rope elongation follows from the friction requirements, in order to ensure a grip between the hoisting rope and the traction sheave that is sufficient in respect of operation and safety of the elevator. On the other hand, in respect of operation and safety of the elevator, it is essential that the rope below the elevator car of an elevator without counterweight is held under sufficient tension. This can not necessarily be achieved by using a spring or a simple lever.

In the following, the invention will be described in detail with reference to embodiment examples and the attached drawings, wherein

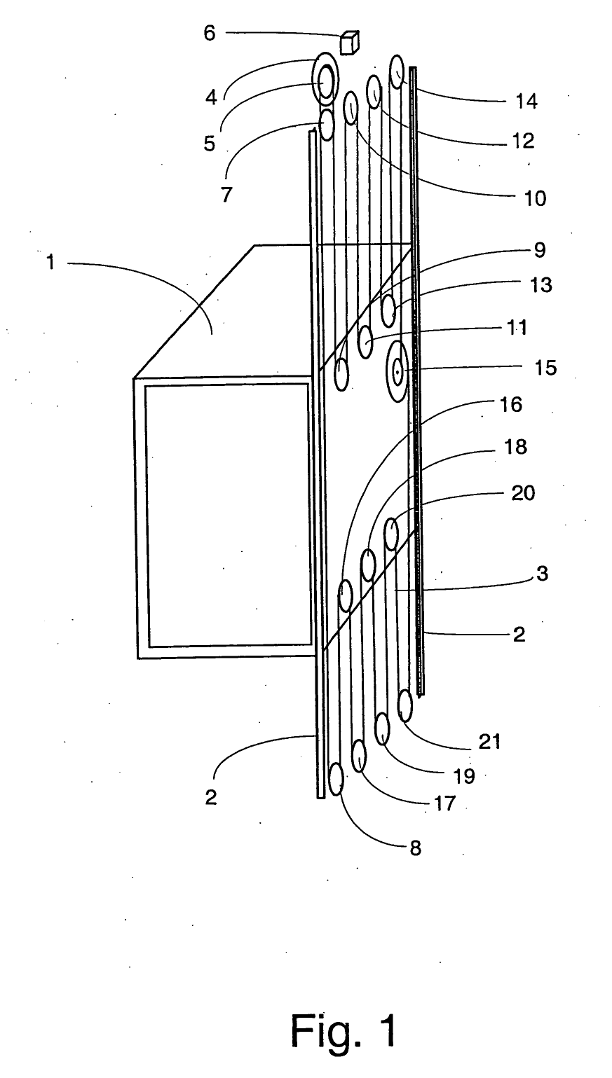

FIG. 1 is a diagram representing a traction sheave elevator without counterweight according to the invention,

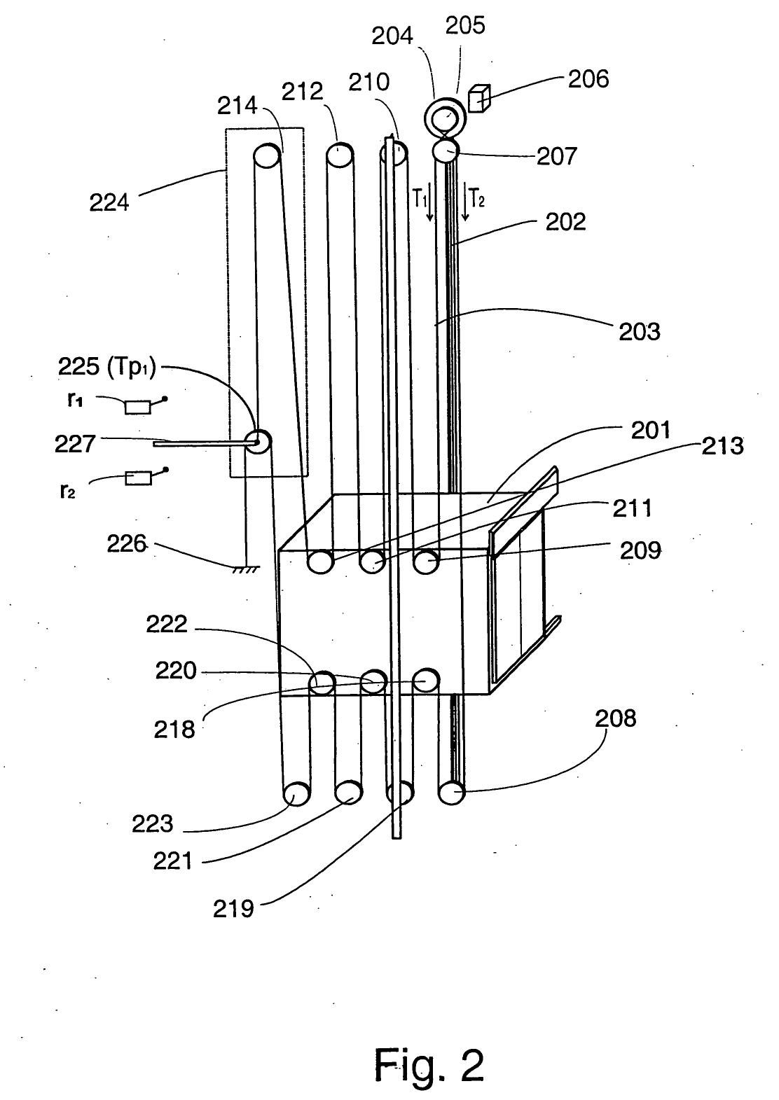

FIG. 2 is a diagram representing a second traction sheave elevator without counterweight according to the invention and a compensating device according to the invention, and

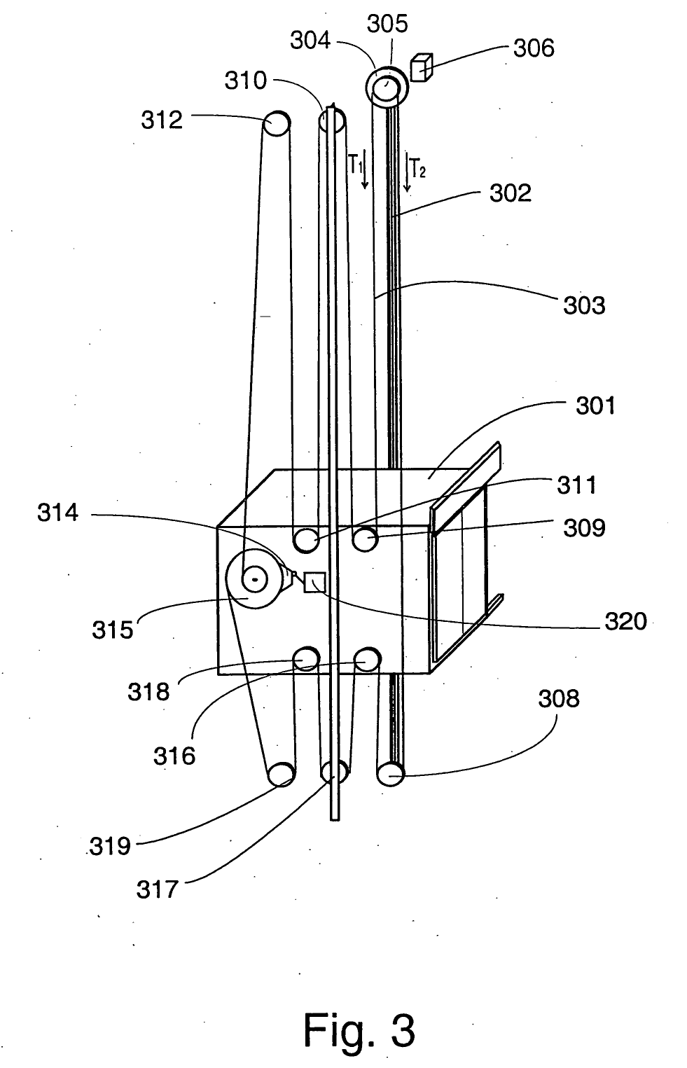

FIG. 3 is a diagram representing a third traction sheave elevator without counterweight according to the invention and a compensating device according to the invention.

FIG. 1 presents a general view of a traction sheave elevator without counterweight according to the invention without a switching element in the compensating system for monitoring rope elongation, in which elevator the elevator guide rails are arranged on one side of the elevator car. The elevator is preferably an elevator without machine room and with a drive machine 4 placed in the elevator shaft. The elevator presented in the figure is a traction sheave elevator without counterweight and with machine above, in which the elevator car 1 moves along guide rails 2. The elevator presented in FIG. 1 is a side rucksack-type elevator in which the elevator guide rails 2, hoisting machine 4, diverting pulleys, rope compensating device 15 and hoisting ropes 3 are arranged on one side of the elevator car 1, which in this case is located to the right of the elevator car 1 as seen from the door opening towards the elevator shaft. This arrangement can also be implemented on any side of the elevator car 1, such as e.g. in the case of a rucksack solution in the space between the back wall of the elevator car and the elevator shaft. The elevator can also be implemented by placing the guide rails of the elevator car and some of the diverting pulleys on different sides of the elevator car. In FIG. 1, the hoisting rope compensating device 15, which in the case of FIG. 1 can also be referred to as a tensioning sheave assembly, comprises two wheel-like bodies fitted to each other, which preferably are sheaves and which in the situation illustrated in FIG. 1 are secured to the elevator car 1. Of the wheel-like bodies, the diameter of the sheave connected to the hoisting rope portion below the elevator car is larger than the diameter of the sheave connected to the hoisting rope portion above the elevator car. The diameter ratio between the diameters of the sheaves determines the magnitude of the tensioning force acting on the hoisting rope and therefore the compensation force needed to compensate the hoisting rope elongations as well as the length of the rope elongation compensated by the compensating device. In this solution, the use of sheaves provides the advantage that the structure can compensate even very large rope elongations. By varying the diametric size of the tensioning sheaves, it is possible to influence the magnitude of the rope elongation to be compensated and the ratio between the rope forces acting over the traction sheave, which ratio can be maintained at a constant value by the arrangement in question. Due to a large suspension ratio or a large hoisting height, the length of the rope used in the elevator is large. It is therefore essential for the operation and safety of the elevator that the hoisting rope portion below the elevator car be held under a sufficient tension, and often the amount of rope elongation to be compensated is large. In the case of odd suspension ratios above and below the elevator car, the compensating device 15 is fitted in conjunction with the elevator car, and in the case of even suspension ratios the compensating device 15 is fitted in the elevator shaft or in some other appropriate place not in conjunction with the elevator car. In the solution it is possible to use two sheaves as illustrated in FIG. 1 in the compensating device 15, but the number of wheel-like bodies used may vary; for example, it is possible to use only one sheave with positions for hoisting rope fastening points of different diameters fitted on it. It is also possible to use more than two tensioning sheaves if it is desirable e.g. to vary the diameter ratio between the sheaves by only changing the diameter of the tensioning sheaves. In addition, the compensating device 15 used may also consist of a different type of compensating device, such as e.g. a lever, a different compensating sheave assembly application or some other compensating device application suited to the purpose.

In FIG. 1, the hoisting ropes run as follows: One end of the hoisting ropes is secured to the sheave of smaller diameter in the compensating device 15, which sheave is immovably fitted fast to the sheave of larger diameter, to which larger sheave the other end of the hoisting ropes 3 is secured. This compensating device 15 has been fitted in place on the elevator car. From the compensating device 15, the hoisting ropes 3 go upwards and meet a diverting pulley 14 placed above the elevator car in the elevator shaft, preferably in the upper part of the elevator shaft, passing around it along rope grooves provided on the diverting pulley 14. These rope grooves may be coated or uncoated, the coating used is e.g. a friction-increasing material, such as polyurethane or some other appropriate material. From diverting pulley 14, the ropes go further downwards to a diverting pulley 13 fitted in place on the elevator car, and having passed around this pulley the ropes go further upwards to a diverting pulley 12 fitted in place in the upper part of the elevator shaft. Having passed around diverting pulley 12, the ropes come again downwards to a diverting pulley 11 fitted in place on the elevator car, pass around it and go further upwards to a diverting pulley 10 fitted in place in the upper part of the elevator shaft, and having passed around this pulley the hoisting ropes 3 go further downwards to a diverting pulley 9 fitted in place on the elevator car. Having passed around this pulley 9, the ropes 3 go further upwards in tangential contact with diverting pulley 7 to the traction sheave 5. Diverting pulley 7 is preferably fitted near and/or in conjunction with the hoisting machine 4. Between diverting pulley 7 and the traction sheave 5, the figure shows Double Wrap (DW) roping, in which roping the hoisting ropes 3 go in tangential contact with diverting pulley 7 upwards to diverting pulley 5 and, having passed around the traction sheave 5, the hoisting ropes return to diverting pulley 7, pass around it and go back to the traction sheave 5. In Double Wrap roping, when diverting pulley 7 is substantially the same size with the traction sheave 5, diverting pulley 7 may also function as a damping pulley. In this case, the ropes going from the traction sheave 5 to the elevator car 1 pass via the rope grooves of the diverting pulley 7 and the deflection of the rope caused by the diverting pulley is very small. It could be stated that the ropes going from the traction sheave to the elevator car and the ropes coming to it only run in “tangential contact” with the diverting pulley. Such “tangential contact” functions as a solution damping vibrations of the outgoing ropes and it can also be applied in other roping solutions. An example of other roping solutions is Single Wrap (SW) roping, wherein the diverting pulley is substantially of the same size with the traction sheave and the diverting pulley is used as a “tangential contact sheave” as described above. In the SW roping according to the example, the ropes are passed only once around the traction sheave, so the contact angle of the rope on the traction sheave is about 180° and the diverting pulley is only used as an auxiliary sheave for “tangential contact” of the rope as described above and wherein the diverting pulley functions as a rope guide and a damping pulley suppressing vibrations. Diverting pulleys 14,13,12,11,10,9,7 together with the traction sheave 5 of the hoisting machine and the compensating device 15 form the suspension above the elevator car, which has the same suspension ratio as the suspension below the elevator car, which suspension ratio in FIG. 1 is 7:1. From the traction sheave 5, the ropes go further in tangential contact with diverting pulley 7 to a diverting pulley 8, which is preferably fitted in place in the lower part of the elevator shaft. Having passed around diverting pulley 8, the ropes 3 go further upwards to a diverting pulley 16 fitted in place on the elevator car, and having passed around this pulley the ropes go further downwards to a diverting pulley 17 in the lower part of the elevator shaft, pass around it and return to a diverting pulley 18 fitted in place on the elevator car. Having passed around diverting pulley 18, the ropes go further downwards to a diverting pulley 19 in the lower part of the elevator shaft and, having passed around this pulley, the ropes go further upwards to a diverting pulley 20 on the elevator car. Having passed around diverting pulley 20, the hoisting ropes 3 go further downwards to a diverting pulley 21 fitted in place in the lower part of the elevator shaft, pass around it and go further upwards to the compensating device 15 fitted in place on the elevator car, the second end of the hoisting ropes being secured to the sheave of larger diameter in the compensating device. Diverting pulleys 8,16,17,18,19,20,21 and the compensating device 15 form the hoisting rope suspension below the elevator car. The hoisting machine 4 and traction sheave 5 of the elevator and/or the diverting pulleys 7,10,12,14 in the upper part of the elevator shaft may be mounted in place on a frame structure formed by the guide rails 2 or on a beam structure at the upper end of the elevator shaft or separately in the elevator shaft or on some other appropriate mounting arrangement. The diverting pulleys in the lower part of the elevator shaft may be mounted in place on a frame structure formed by the guide rails 2 or to a beam structure placed at the lower end of the elevator shaft or separately in the lower part of the elevator shaft or on some other appropriate mounting arrangement. The diverting pulleys on the elevator car may be mounted in place on the frame structure of the elevator car 1 or to a beam structure or beam structures in the elevator car or separately on the elevator car or some other appropriate mounting arrangement. The tensioning sheave assembly 15 used as a rope elongation compensating device as illustrated in FIG. 1 can also be advantageously placed to replace diverting pulley 21 on the bottom of the shaft, which pulley is preferably secured in place to the floor of the shaft, or diverting pulley 14 in the upper part of the shaft, which pulley is preferably secured in place to the ceiling of the shaft if an even suspension ratio is used, in which case the compensating device is not mounted in conjunction with the elevator car. In this case, the number of diverting pulleys needed is smaller by one. In advantageous cases, this also allows easier and faster installation of the elevator.

FIG. 2 presents a diagram illustrating the structure of an elevator according to the invention. The elevator is preferably a traction sheave elevator without machine room and with a drive machine 204 placed in the elevator shaft. The elevator presented in the figure is a traction sheave elevator without counterweight and with machine above, in which the elevator car 201 moves along guide rails 202. In elevators designed for a large hoisting height, elongation of the hoisting rope involves a need to compensate the rope elongation, and this has to be done reliably within certain allowed limit values. In the rope force equalizing sheave assembly 224 of the invention presented in FIG. 2, a very long movement for the compensation of rope elongation is achieved. This allows compensation of even very large elongations, which is often not possible if simple lever or spring solutions are used. The compensating device is also used to ensure safe operation of the elevator in other situations where the safety of the elevator is impaired. The operation of the compensating device is to be monitored to ensure that it will not be used in an operating range where the reliability and safety of the elevator would be impaired. As a compensating device according to the invention, FIG. 2 presents an arrangement of compensating sheaves that maintains a substantially constant ratio T₁/T₂ between the rope forces T₁ and T₂ acting over the traction sheave. The compensating device has a limited compensating distance due to its structure, e.g. the fact that the compensating device is guided by guide rails and the compensating range between their ends is a range that forms the theoretic limited operating range of the compensating device, within which range the compensating device maintains a difference of tension between T_{1 and T}₂ and between different parts of the hoisting ropes. Within this range, the compensating device works in the desired manner, but when the extremities of the compensating device are reached, such as e.g. the fixing point 226 of the hoisting ropes, the compensating device will not necessarily function in the desired manner and the operation of the elevator is impaired. Thus, the compensating device generally has a first range, which is a structural operating range, and/or a theoretical compensation range, within which the compensating device functions in a known and desired manner but beyond which it will not necessarily function in the desired manner. For this reason, it is desirable to select in the compensating device a second range which is to be monitored by means of switching elements and which is a preselected compensation range of the compensating device, within which range the compensating device works in the desired manner. This arrangement is designed to ensure that the compensating device is operated in a certain range within which the compensating device works in the desired manner. If necessary, the preselected compensation range can also be defined as a range equal to the structural operating range. It is also possible to have more than one such compensation range monitored by means of switching elements in the compensating device. For example, in a situation where information is to be transmitted to an elevator maintenance or remote monitoring system to indicate that the preselected limit has been exceeded and the elevator needs maintenance but its operation is not yet impaired and the elevator remains in normal use. In addition to this, the above-mentioned system comprises at least a second predefined compensation range, which is larger than the compensation range selected by means of the switching elements transmitting information to the maintenance system, upon activation of the switching elements of which range the operation of the elevator is stopped and/or prevented. FIG. 2 also shows switching elements r₁ and r₂ comprised in the compensating device, which elements are used to monitor the position of a compensating sheave 225 or Tp₁ in the compensating sheave assembly. By means of the switching elements, a preselected compensation range is defined for the compensating device 224. This range is generally smaller than the theoretical limited operating range, which e.g. in the situation illustrated in FIG. 2 is limited at its upper end by the upper ends of the guide rails guiding the compensating device and at its lower end by a buffer placed at the fixing point 226 or some other suitable point. The structural operating range and the preselected compensation range may also be equal if necessary. Fitted in place on the diverting pulley 225 (Tp₁) is a connecting element 227 designed to engage the switching elements r₁ and r₂ to activate them so that they will receive limit information regarding the position of the compensating sheave Tp₁. The switching elements can also be activated by some other technique applicable to the purpose. The switching elements are used to indicate that the compensating device is working outside the preselected compensation range. In an elevator without counterweight according to the invention, the condition of the parallel ropes in the set of hoisting ropes 203 can be monitored e.g. by means of a compensating device. In the arrangement according to the invention as illustrated in FIG. 2, the compensating sheave assembly 224 used as a rope force compensating device is provided with switching elements r₁,r₂, such as limit switches, fitted to monitor the position of the diverting pulley 225 (Tp₁). When for some reason the length of the hoisting ropes 203 has been increased too much, the above-mentioned switching elements will transmit information to the elevator control system, which again can e.g. inform the elevator remote monitoring system that the elevator needs maintenance, or the switching element may send information regarding its activation directly to the remote monitoring system. If the elongation of the hoisting rope increases to a dangerous length, the limit data obtained from the switching elements can stop the elevator and/or prevent the use of the elevator if desired.

In the elevator and compensating device according to the invention, it is also possible to use more switching elements than in the examples in the present application; for instance, in the situation illustrated in FIG. 2, it is possible to use several switching elements to indicate different preselected compensation ranges of the compensating device and occurrences of the device exceeding the range. For example, switching elements used to indicate a need for maintenance may be fitted to work from a smaller compensation range than switching elements stopping the elevator. Situations that cause the compensating device to move outside the preselected compensation range and/or to the end of the maximum operating range may include e.g. various disturbance and danger situations in the elevator, such as diverting pulleys being damaged or getting stuck, disturbances of rope passage in the elevator, changes in rope lengths e.g. due to an excessive rope elongation, situations where the elevator is driven onto the buffer or the safety gear grips and/or other corresponding disturbance situations in which the compensating device moves outside the predefined compensation range.

In FIG. 2 the hoisting ropes run as follows: One end of the hoisting ropes 203 is secured to a diverting pulley 225 fitted to hang on a rope portion coming downwards from diverting pulley 214. Diverting pulleys 214 and 225 together constitute a rope force equalizing system 224, which in the case illustrated in FIG. 2 is a compensating sheave assembly. From diverting pulley 214, the hoisting ropes run further as described in connection with the previous figures between the diverting pulleys 212,210,207 fitted in place in the upper part of the elevator shaft and the diverting pulleys 213,211,209 fitted in place on the elevator car, forming the suspension above the elevator car. Between the traction sheave 205 of the hoisting machine 204 and diverting pulley 207, X Wrap (XW) roping is used, in which roping the rope portion of the hoisting ropes going upwards from the diverting pulley 207 to the traction sheave 205 and the rope portion returning from the traction sheave 205 to the diverting pulley 207 run across each other. Diverting pulleys 214,213,212,211,210,209,207 together with the traction sheave 205 of the hoisting machine 204 form the suspension above the elevator car, which has the same suspension ratio as the suspension below the elevator car, which suspension ratio in FIG. 2 is 6:1. Between diverting pulley 207 and the traction sheave it is also possible to use other types of roping appropriate for the purpose, such as e.g. the known SW, DW tai ESW roping solutions or some other appropriate roping solution. From the traction sheave, the hoisting ropes go further via diverting pulley 207 to a diverting pulley 208 placed in the lower part of the shaft. Having passed around diverting pulley 208, the hoisting ropes run between the diverting pulleys 218,220,222 fitted in place on the elevator car 201 and the diverting pulleys 219,221,223 fitted in place in the lower part of the elevator shaft, as described in connection with the previous figures. From diverting pulley 223, the hoisting ropes 203 go further to diverting pulley 225, which is comprised in the rope force equalizing sheave assembly 224 and is fastened to the second end of the hoisting rope. Having passed around diverting pulley 225 along its rope grooves, the rope goes further to the fixing point 226 of the second end of the hoisting rope, this fixing point being located in the elevator shaft or in some other place appropriate for the purpose. Diverting pulleys 208,218,219,220,221,222,223 form the suspension below the elevator car, in which the suspension ratio is the same as the suspension ratio of the suspension above the elevator car, i.e. 6:1 in the situation of FIG. 2. Diverting pulley 225 may be guided by guide rails to keep it on its track, especially in situations where the compensating sheave assembly 224 is subjected to a hard impact, such as e.g. when the safety gear of the elevator grips. By means of the guide rails of the compensating sheave 225, a desired clearance between the elevator car and the compensating device can be maintained and the motion of the compensating device controlled. The guide rails used with the compensating device may be almost any type of guide rails applicable for the purpose, such as e.g. guide rails made of metal or some other appropriate material or e.g. guide ropes.

In the elevator presented in FIG. 2, the compensating sheave assembly 224 compensates rope elongations by means of a diverting pulley 225 (Tp₁). The diverting pulley 225 moves through distance 1, compensating elongations of the hoisting ropes 203. The compensation distance 1 is half the elongation of the hoisting ropes. In addition, this arrangement keeps the rope tension over the traction sheave 205 at a constant level, so that the T₁/T₂ ratio between the rope forces is 2/1. By means of the switching elements r₁ and r₂, a compensation range has been preselected for the compensating device, which will work in the desired manner as long as it remains within this range. The structural operating range of the compensating device is the maximal distance through which the compensating sheave assembly 224 can move while maintaining a tension difference between the rope portions above and below the elevator car, when the upper end is reached the compensating device will not compensate the rope elongation upwards. In the situation illustrated in FIG. 2, the compensating device moves upwards normally when the elevator car moves downwards. When the compensating device is in a situation where it no longer moves upwards compensating the rope elongation, a situation arises where the rope force T₁ of the rope portion above the elevator car increases while the rope elongation in the hoisting rope simultaneously increases. The compensating device can no longer perform the compensation function and at the same time the rope portion below the elevator car becomes slack and its tension T₂ decreases. The compensating device is not working properly, so the T₁/T₂ ration does not remain constant, and consequently the rope portion below the elevator car becomes slack and the tension acting over the traction sheave changes, which leads to a loss of friction between the hoisting ropes and the traction sheave. This situation is dangerous for the operation of the elevator as the elevator hoisting rope starts slipping and the elevator car can move downwards in an uncontrolled manner. After the compensating device has moved to the limit of the second end of the maximal operating range, in the situation in FIG. 2 to the fixing point 226 of the hoisting rope, a situation arises where T₂ is increasing and the rope elongation in the portion below the elevator car is increasing. As a consequence of this, the rope portion above the elevator car becomes slack and the rope force T₁ decreases as the compensating device is not compensating the rope elongations and equalizing the rope forces. In this situation the elevator hoisting machine only tries to feed more rope to the rope portion above the elevator car while the tension of the rope portion below the elevator car is further increased. The compensating sheave assembly 224 used as a compensating device can also be implemented in other ways besides that presented in the example, such as by using more complex suspension arrangements in the rope force compensating sheave assembly, e.g. different suspension ratios between the diverting pulleys in the compensating sheave assembly. Examples of such different suspension ratios in the compensating sheave assembly are 3:1, 3:2 or some other appropriate suspension ratio.

FIG. 3 illustrates the structure of an elevator according to the invention. The elevator is preferably an elevator without machine room and with a drive machine 304 placed in the elevator shaft. The elevator presented in the figure is a traction sheave elevator without counterweight and with machine above, in which the elevator car 301 moves along guide rails 302. In FIG. 3, a compensating sheave assembly 315 as described in connection with FIG. 1 is used a compensating device, which comprises two wheel-like bodies, preferably sheaves, fixed to each other, which sheave assembly in the case of FIG. 3 has been fitted in place on the elevator car 301. In the tensioning sheave assembly 315 used as a compensating device, the sheave connected to the hoisting rope portion below the elevator car has a larger diameter than the sheave connected to the hoisting rope portion above the elevator car. The diameter ratio between the diameters of the sheaves in the tensioning sheave assembly determines the magnitude of the tensioning force acting on the hoisting rope and the compensation distance needed to compensate the hoisting rope elongations, as well as the ratio between T_{1 and T}₂. In this solution, the use of tensioning sheaves provides the advantage that the structure can compensate even large rope elongations. By varying the diametric size of the tensioning sheaves, it is possible to influence the magnitude of the compensation range and distance and the ratio between the rope forces T_{1 and T}₂ acting over the traction sheave, which ratio can be maintained at a constant value by the arrangement in question. Due to a large suspension ratio or a large hoisting height, the length of the rope used in the elevator is large. It is therefore essential for the operation and safety of the elevator that the hoisting rope portion below the elevator car be held under a sufficient tension and the amount of rope elongation to be compensated is sufficiently large. Often this can not be implemented using a spring or a simple lever. In the case of odd suspension ratios above and below the elevator car, the tensioning sheaves are fitted in conjunction with the elevator car, and in the case of even suspension ratios the tensioning sheaves are fitted in the elevator shaft or in some other appropriate place not in conjunction with the elevator car. In the solution it is possible to use two sheaves, but the number of wheel-like bodies used may vary; for example, it is possible to use only one sheave with positions for hoisting rope fastening points of different diameters fitted on it. It is also possible to use more than two tensioning sheaves if it is desirable e.g. to vary the diameter ratio between the sheaves by only changing the diameter of the tensioning sheaves. In addition, when a tensioning sheave assembly 315 is used as a compensating device in the elevator of the invention, it is necessary to monitor the compensating device to ensure that it remains within the selected compensation range. The monitoring can be advantageously implemented e.g. as in FIG. 3, where the tensioning sheave assembly is provided with a switching element 320, which is activated e.g. by means of a bracket 314 provided on the compensating device 315. By shaping the bracket 314 in a suitable way, it is possible to monitor both ends of the preselected compensation range by means of a single switching element in a manner corresponding to that applied in connection with the compensating device presented in FIG. 2. The safe compensation range in the tensioning sheave assembly is normally somewhat less than a full revolution. The structural operating range depending on the structure of the tensioning sheave assembly is larger than the preselected compensation range, which is monitored by means of at least one switching element to ensure that the compensating device is functioning in the desired manner. The bracket 314 can be designed to a size of e.g. 20% to ensure reliable activation of the switching element 320, and disposed at a suitable point on the tensioning sheave assembly 315.

In FIG. 3, the hoisting ropes run as follows: One end of the hoisting ropes is secured to the sheave of smaller diameter in the tensioning sheave assembly 315. This tensioning sheave assembly 315 has been fitted fast to the elevator car. From the sheave of smaller diameter, the hoisting ropes 303 go upwards and meet a diverting pulley 312 placed above the elevator car in the elevator shaft, preferably in the upper part of the elevator shaft, passing around it along rope grooves provided on the diverting pulley 312. These rope grooves may be coated or uncoated, the coating used may be e.g. a friction-increasing material, such as polyurethane or some other appropriate material. From pulley 312, the ropes go further downwards to a diverting pulley 311 on the elevator car, and having passed around this pulley the ropes go further upwards to a diverting pulley 310 fitted in the upper part of the shaft. Having passed around diverting pulley 310, the ropes come again downwards to a diverting pulley 309 mounted on the elevator car, pass around it and go further upwards to the traction sheave 305 of the hoisting machine 304. The roping presented in FIG. 3 is Single Wrap (SW) roping, in which no auxiliary diverting pulleys are used. Diverting pulleys 312,311,310,309 together with the traction sheave of the hoisting machine and the tensioning sheave assembly 315 constitute the suspension above the elevator car, wherein the suspension ratio is the same as in the suspension below the elevator car, this suspension ratio in FIG. 3 being 5:1. From the traction sheave 305, the ropes go further to a diverting pulley 308 preferably fitted in place in the lower part of the elevator shaft, e.g. on an elevator guide rail 302 or on the shaft floor or in some other appropriate place. Having passed around diverting pulley 308, the ropes 303 go further upwards to a diverting pulley 316 fitted in place on the elevator car, pass around it and run further downwards to a diverting pulley 317 in the lower part of the elevator shaft. Having passed around this pulley, the ropes return to a diverting pulley 318 fitted in place on the elevator car. Having passed around diverting pulley 318, the hoisting ropes 303 go further downwards to a diverting pulley 319 fitted in place in the lower part of the elevator shaft, and having passed around this diverting pulley the ropes go further upwards to the tensioning sheave assembly 315 fitted in place on the elevator car, the second end of the hoisting ropes 303 being secured to the sheave of larger diameter in the tensioning sheave assembly.

A preferred embodiment of the elevator of the invention is an elevator without machine room and with machine above, in which the drive machine has a coated traction sheave and which elevator has thin and hard hoisting ropes of a substantially round cross-section. In the elevator, the contact angle of the hoisting ropes on the traction sheave is greater than 180° and preferably implemented using DW roping in the hoisting machine. The hoisting machine has a traction sheave and a diverting pulley, in which hoisting machine the traction sheave and the diverting pulley are ready fitted in a correct angle relative to each other. The hoisting machine is secured to the elevator guide rails. The elevator is implemented without counterweight with a suspension ratio of 8:1 in such a way that both the suspension ratio in the roping above the elevator car and the suspension ratio in the roping below the elevator car is 8:1, and that the ropes of the elevator run in a space between one wall of the elevator car and the wall of the elevator shaft. The elevator has a compensating device, which maintains a constant ratio between forces T₁/T₂ as 2:1. With the compensating device used, the required compensation distance equals half the magnitude of the rope elongation. In addition, the compensating device is provided with at least one switching element to monitor whether the device remains within the preselected compensation range.

Another preferred embodiment of the elevator of the invention is an elevator without counterweight in which the suspension ratio above and below the elevator car is 10:1. This embodiment uses conventional elevator ropes, which preferably are ropes of a diameter of 8 mm, and a traction sheave made of cast iron at least in the area of the rope grooves. The traction sheave has undercut rope grooves and the contact angle on the traction sheave has been fitted by means of a diverting pulley to be 180° or greater. When conventional 8-mm ropes are used, the traction sheave preferably has a diameter of 340 mm. The diverting pulleys used are large rope sheaves which, when conventional 8-mm hoisting ropes are used, have a diameter of 320, 330 340 mm or even more.

It is obvious to the person skilled in the art that different embodiments of the invention are not limited to the examples described above, but that they may be varied within the scope of the claims presented below. For example, the number of times the hoisting ropes are passed between the upper part of the elevator shaft and the elevator car and between the diverting pulleys in the lower part of the elevator shaft and the elevator car is not a very decisive question as regards the basic advantages of the invention, although it is possible to achieve some additional advantages by using multiple rope portions. Embodiments are generally so implemented that the ropes are passed to the elevator car as many times from above as from below, so that the suspension ratios in the suspension above and below the elevator car are the same. It is likewise obvious that the hoisting ropes need not necessarily be passed under the car, but that they can as well be passed e.g. over the car. In accordance with the examples described above, the skilled person can vary the embodiment of the invention as the traction sheaves and rope pulleys, instead of being coated metal pulleys, may also be uncoated metal pulleys or uncoated pulleys made of some other material suited to the purpose.

It is further obvious to the person skilled in the art that the traction sheaves and rope pulleys made of metal or some other material appropriate for the purpose which are used as diverting pulleys in the invention and which are coated with a non-metallic material at least in the area of their grooves may be implemented using a coating material consisting of e.g. rubber, polyurethane or some other material suited to the purpose.

It is obvious to the skilled person that the elevator of the invention can be implemented using as hoisting ropes almost any flexible hoisting means, e.g. a flexible rope of one or more strands, a flat belt, a cogged belt, a trapezoidal belt or some other type of belt suited to the purpose. It is obvious to the skilled person that, instead of using ropes with a filler, the invention can be implemented using ropes without a filler, which are either lubricated or unlubricated. In addition, it is also obvious to the skilled person that the ropes may be twisted in many different ways.

It is also obvious to the person skilled in the art that the elevator of the invention can be implemented using other types of roping between the traction sheave and the diverting pulley/diverting pulleys to increase the contact angle α than the roping arrangements described above as examples. For example, it is possible to arrange the diverting pulley/diverting pulleys, traction sheave and hoisting ropes in other ways than in the roping examples presented. It is further obvious to the skilled person that the elevator of the invention may also be provided with a counterweight, in which elevator, for example, the counterweight preferably has a weight below that of the car and is suspended on separate ropes.

Due to the bearing resistance of the rope sheaves used as diverting pulleys and the friction between the ropes and the rope sheaves and also to possible losses occurring in the compensating device, the ratio of the rope tensions may deviate somewhat from the nominal ratio of the compensating device. Even a 5-% deviation is not a significant detriment because the elevator must in any case have a certain in-built robustness.

1. An elevator, preferably an elevator without counterweight, which has an elevator car suspended by means of a set of hoisting ropes comprising one rope or a plurality of parallel ropes and which elevator has a traction sheave that moves the elevator car by means of the hoisting ropes, and which elevator comprises rope portions of hoisting ropes going upwards and downwards from the elevator car, and which elevator has a compensating device acting on the hoisting ropes to equalize and/or compensate rope tension and/or rope elongation, wherein the compensating device acting on the hoisting ropes of the elevator, said compensating device having at least a first range which is a structural operating range of the compensating device and at least a second range which is a preselected compensation range of the compensating device, is provided with at least one switching element for monitoring whether the compensating device remains within the preselected compensation range.

2. An elevator according to claim 1, wherein the compensating device is a lever, a tensioning sheave assembly or a compensating sheave assembly or some other compensating device suited to the purpose.

3. An elevator according to claim 1, wherein the compensating device is a tensioning sheave assembly and the switching element is an element detecting whether the preselected compensation range has been exceeded.

4. An elevator according to claim 1, wherein the compensating device comprises a compensating sheave Tp1 and at least a first switching element r1 and a second switching element r2 for monitoring the position of the compensating sheave Tp1 in the compensating device and detecting a deviation from the preselected compensation range.

5. An elevator according to claim 4, wherein the compensating device comprises one and/or more diverting pulleys.

6. An elevator according to claim 1, wherein the compensating device comprises a system that sends information regarding deviation from the preselected compensation range to a remote monitoring system and/or prevents the use of the elevator.

7. An elevator according to claim 1, wherein the elevator car is provided with diverting pulleys from which the hoisting ropes go upwards and diverting pulleys from which the hoisting ropes go downwards, the number of each type of pulleys being 1,2,3,4,5 or even more.

8. An elevator according to claim 1, wherein the roping used between the traction sheave and the diverting pulley is DW roping or XW roping or SW roping or other corresponding roping that forms a continuous contact angle of at least 180° between the traction sheave and the hoisting ropes.

9. A method for detecting a deviation of a compensating device from a preselected compensation range in an elevator, in which elevator the elevator car is at least partially suspended by means of a set of hoisting ropes comprising at least one rope or a plurality of parallel ropes, and which elevator has a traction sheave that moves the elevator car by means of the hoisting ropes, and which elevator comprises rope portions of hoisting ropes going upwards and downwards from the elevator car, and which elevator has a compensating device acting on the hoisting ropes to equalize and/or compensate rope tension, wherein monitoring is performed in the compensating device by means of at least one switching element to detect whether the compensating device of the elevator remains within the preselected compensation range.

10. A method according to claim 9, wherein, after the switching element in the compensating device has detected a deviation from the preselected compensation range, corresponding information is sent to a remote elevator monitoring system and/or the use of the elevator is prevented in such a situation.
